(19) United States
(12) Patent Application Publication
(10) Pub. No.: US 2004/0146706 A1
(43) Pub. Date: Jul. 29, 2004

(54) Protective film,adhesive sheet and floor surface protective structure

(76) Inventors: Toshihiro Kasai, Sagamihara Kanagawa (JP); Takahide Okuyama, Yamagata Yamagata (JP); Toshinori Naruse, Sagamihara Kanagawa (JP)

Correspondence Address: 3M INNOVATIVE PROPERTIES COMPANY, PO BOX 33427, ST. PAUL, MN, 55133-3427, US

(21) Appl. No.: 10/477,416

(22) PCT Filed: Jun. 14, 2002
(86) PCT No.: PCT/US02/18899

(30) Foreign Application Priority Data
Jun. 19, 2001 (JP) 2001-185356

(51) Int. Cl. C01B 25/01

(52) U.S. Cl. 428/328; 423/323; 428/343

(57) ABSTRACT

To provide an adhesive film having a high durability. A protective film comprising a cured resin and a filler dispersed in said cured resin, wherein said filler is composed of ceramic particles made of a composition containing alumina and zirconia, and said zirconia has mainly a tetragonal crystal form and is dispersed in said ceramic particles.

### FIELD OF THE INVENTION

The present invention relates to a protective film and, more particularly, to an abrasion and scratch resistant protective film for use on flooring and other floor surfaces.

### FIELD OF THE INVENTION

Presentation of a varicolored space has recently been performed by using a sheet having an excellent decorative effect (hereinafter also referred to as a “decorative sheet”) in outdoor and indoor information and advertisement. It has recently become possible to utilize any space for advertisement and information (e.g. directional sign or guidance) by attaching a decorative sheet to any floor surfaces such as in front of escalators, entrances of exhibit halls, counters of supermakets, and ATM (Automated Teller Machines) of banks.

When this decorative sheet is attached to the floor surface as described above, the decorative sheet should not lose the decorative effect even when exposed to the high foot traffic. Therefore, an adhesive sheet having a decorative surface layer of the decorative sheet is generally covered with a transparent protective film having a mechanical durability such as abrasion resistance or scratch resistance, or a mechanical strength, thereby maintaining a desired strength and a desired appearance through the protective film. As disclosed in the form of a protective layer (particularly surface layer) in Unexamined Patent Publication (Kokai) No. 2000-191993, a typical protective film contains fillers made of transparent beads such as glass beads, ceramic beads, glass ceramic beads, hard polymer beads and the like.

Therefore, an object of the present invention is to provide a protective film, the mechanical durability of which is more enhanced by the filler having a high hardness without impairing the above appearance, an adhesive sheet using the same, and a floor surface structure.

### SUMMARY OF THE INVENTION

Briefly, in one aspect of the present invention, a protective film is provided as a protective layer in an adhesive film comprising a base layer, the protective layer which covers one surface of the base layer, and an adhesive layer formed on the other surface of the base layer. According to the present invention, there is provided a floor surface structure comprising a floor material, and an adhesive sheet applied on the floor material.

According to one embodiment of the present invention, a protective film comprises a cured resin and a filler dispersed in the cured resin, wherein the filler is composed of ceramic particles made of a composition containing alumina and zirconia, and the zirconia has mainly a tetragonal crystal form and is dispersed in the ceramic particles.

To further enhance the mechanical durability of the protective film, the filler preferably has a hardness as high as possible. The hardness of the transparent beads as the filler is within a range from about 900 to 1300 kg/mm² in terms of Vickers hardness and the filler must have a higher hardness according to the purposes. It is also required that, even if the hardness of the filler is more enhanced, the protective film can maintain the appearance of the decorative sheet.

### BRIEF DESCRIPTION OF THE DRAWINGS

FIG. 1 is a schematic sectional view showing an adhesive sheet according to the present invention.

### DESCRIPTION OF THE PREFERRED EMBODIMENTS

With reference to the accompanying drawings, the present invention will be described by way of embodiments.

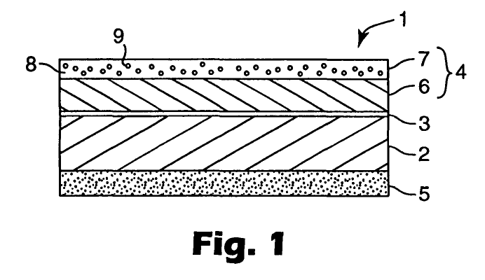

FIG. 1 is a side sectional view schematically showing an adhesive sheet 1 using a protective film 7 of the present invention, in which 2 denotes a base layer, 3 denotes a decorative surface layer, 4 denotes a protective layer, and 5 denotes an adhesive layer.

The base layer 2 is a layer for supporting the protective layer 4 including the protective film 7 of the present invention, properly maintaining the mechanical strength of the entire adhesive sheet 1, and carrying the decorative surface layer 3 for imparting decorative appearance to the sheet surface. The thickness of the base layer is typically within a range from 10 to 150 μm to impart the mechanical strength to the adhesive sheet. The thickness of the base layer is preferably within a range from 15 to 120 μm in view of the masking property and availability. A typical base layer is formed from a paper, a resin such as polyvinyl chloride (including copolymer of other vinyl monomer), polyolefin, polyurethane, polyacrylate (i.e. acrylic resin), polyester or silicone (including silicone polyurea) or a metal such as aluminum or copper. Among these materials, the base layer is preferably made from polyvinyl chloride, polyurethane or polyacrylate (i.e. acrylic resin) in view of the printability, durability and processability.

The decorative surface layer 3 is a layer that is optionally formed to provide images such as literatures and designs on the sheet surface, thereby to impart the decorative effect. A decorative sheet is formed by forming this decorative surface layer on the adhesive sheet of the present invention. As shown in FIG. 1, this decorative surface sheet may be formed on the outermost layer of the base layer 2, or formed in the interior of the base layer, or formed on the innermost layer, i.e. the surface in contact with the adhesive layer 5. Usually, a printed layer formed by a printing means such as screen printing, gravure printing, thermal transfer printing or the like can be used as the decorative surface layer. A metallic deposit layer having a metallic appearance can also be used as the decorative surface layer. Alternatively, this decorative surface layer may be formed by using the both in combination. Also literatures may be formed on the decorative surface layer, thereby making it possible to communicate the information through this sheet.

The base layer 2 and the decorative surface layer 3 are covered with the protective layer 4. Although the protective layer 4 can be formed of only the protective film 7, a primer layer 6 is preferably formed between the protective film 7 and the base layer to enhance the adhesion between them.

The protective film comprises a cured resin 8 and a filler 9 dispersed in the cured resin. The cured resin 8 constitutes a matrix for supporting the filler 9. This cured resin 8 is usually obtained by curing a curable resin such as acrylic resin, polyester, polyurethane, silicone, epoxy resin or the like and has high transparency and excellent abrasion resistance. The cured resin made of polyurethane is particularly tough and has effectively the abrasion resistance. Such polyurethane is commercially available from NIPPON POLYURETHANE INDUSTRY CO., LTD. under the trade name of SH-1011. When using in combination with a curing agent (CORONATE HX) manufactured by the same company, a desired cured resin can be formed by heating or irradiating with radiation (e.g. ultraviolet light, electron beam, etc.). When using this curing agent, the curing agent is usually incorporated in the amount of about 50% by weight or less, preferably about 30% by weight or less, and more preferably about 20% by weight or less, based on 100 parts by weight of the cured resin.

Preferred cured resin has an elastic modulus within a range from 1×10⁹ to 1×10¹⁵ dyn/cm². The reason is that such an elastic modulus is advantageous to the pliability and abrasion resistance of the decorative sheet. Furthermore, the cured resin is preferably transparent as possible. Accordingly, the light transmittance is usually not less than 70%, preferably not less than 80%, and more preferably not less than 90%. The light transmittance is measured by the method in accordance with the “method of measurement of the light transmittance” described in Japanese Industrial Standard JIS K 7105.

The filler 9 is dispersed in the cured resin, and is preferably embedded in the state where a portion thereof is exposed, and can generally impart excellent mechanical durability such as abrasion resistance or scratch resistance, or mechanical strength to the protective film or the adhesive sheet using the same. The filler 9 is made of ceramic particles (hereinafter referred to as “ceramic particles” or referred merely to as “particles”) and makes an article to be contacted with the protective layer to be scarcely scratched. According to the present invention, ceramics particles are composed of a composition containing alumina and zirconia.

Ceramic particles preferably contain alumina in the amount within a range from 90 to 70% by weight, and more preferably from 90 to 80% by weight, and alumina imparts the hardness to the particles. In the present invention, the hardness of the ceramic particles is usually at least about 2000 kg/mm² in terms of Vickers hardness and can further enhance the mechanical strength of the protective layer.

Alumina matrix particles preferably contain zirconia in the amount within a range from 10 to 30% by weight, and more preferably from 10 to 20% by weight. Although zirconia exists in a monoclinic, tetragonal or cubic crystal form depending upon the temperature, according to the present invention, zirconia is dispersed in particles in mainly a tetragonal crystal form and can enhance the toughness of the ceramic particles. When the particles are toughened, the particles are scarcely broken even when subjected to an external force. Furthermore, zirconia is also superior in chemical durability such as chemical resistance. It is particularly superior in alkali resistance. As a result, even when the adhesive sheet is exposed to an alkali detergent during washing, deterioration of the protective layer caused by the particles and lowering of the quality caused by discoloration of the decorative surface layer scarcely occur. Zirconia has mainly a tetragonal crystal form as described above, but it may contain a monoclinic form unless the effect of the present invention is impaired.

The particle diameter of the ceramic particles is usually within a range from 10 to 150 μm, and preferably from 20 to 100 μm. When the particle diameter is too small, the abrasion resistance and scratch resistance are likely to be lowered. On the other hand, when the particle diameter is too small, the transparency of the protective film is likely to be lowered. The reason is that the stain resistance is lowered sometimes by roughening of the surface of the protective film. The particle diameter of the ceramic particles is usually a volume-average diameter measured by using an image processing system equipped with an optical microscope. Generally, the volume-average diameter is calculated by the following equation (1):

Volume-average diameter (μm)=Σ(di⁴·ni)/Σ(di³·ni)

where di denotes a size (diameter) of i^{th} particles and ni denotes the number of particles having a diameter of di.

In the present specification, the volume-average diameter was determined by measuring the size of 1000 ceramic particles using an image processing system equipped with an optical microscope.

According to the present invention, these particles are generally solid. However, as far as the effect of the present invention is not adversely affected, one or more particles having vacancies may be included. It is not necessary that the filler 9 is dispersed in the entire protective film, and only the surface portion of the protective film may contain the filler.

The ceramic particles can be formed by a known and conventional production process of ceramic, but are preferably produced in the following manner. First, a composition containing an alumina precursor powder and a zirconia precursor powder, which are raw materials for alumina and zirconia of ceramic particles, in a predetermined ratio was prepared and then granulated. When the amount of zirconia is too large, the melting point of the composition becomes too higher, thereby making it difficult to molten in flame. Therefore, zirconia is prepared in the amount of not more than about 50% by weight. Then, both powders are uniformly molten by heating the composition in flame. The composition is then quenched to form particles. The particles may be subjected to a heat treatment at 1500° C. or lower for the purpose of preventing the occurrence of strain due to quenching. When the heat treatment temperature is too high, a zirconia crystal in an alumina matrix is transformed into a prismatic crystal, thereby impairing the toughness, which is not preferred.

According to this method, the composition of zirconia and alumina can be uniformly mixed without requiring firing which generally takes a long time. This composition forms ceramic particles after it was once uniformly molten. As a result, the particles has smooth spherical surface and excellent fluidity, which make formation of the protective layer described below advantageous. The touch of the protective layer is also improved. Ceramic particles having a fixed quality can be easily obtained without passing through complicated processes.

As the ceramic particles used in the present invention, there can be used ceramic particles obtained by dispersing tetragonal zirconia having a size within a range from 0.05 to 2 μm into alumina by hydrostatic molding and the following sintering or hot hydrostatic molding using the method disclosed in U.S. Pat. No. 4,218,253, in addition to the method described above.

The ceramic particles may be produced by using not only a single oxide such as zirconia, alumina or the like, but also the single oxide in combination with a double oxide such as zirconium aluminate. In addition to oxides, hydroxides, acid chlorides, chlorides, nitrates, acetates and sulfates may be used.

If necessary, the ceramic particles may further contain additives, for example, alkali metals such as lithium, sodium and potassium; alkali earth metals such as magnesium, calcium and barium; and rare earth elements such as yttrium. To obtain stable tetragonal zirconia, stabilizers such as Y₂O₃, MgO, CaO, CeO₂ and the like may be added to the composition of alumina and zirconia.

To improve the adhesion with the cured resin, the ceramic particles are preferably subjected to a surface treatment with a silane coupling agent.

The content of the ceramic particles in the protective film is preferably within a range from 20 to 150 wt %, and more preferably from 50 to 120 wt %. When the content of the ceramic particles is too small, the scratch resistance is poor. On the other hand, when the content of the ceramic particles is too large, the abrasion resistance is likely to be lowered. Furthermore, when the content of ceramic particles having the above particle diameter is within the above range, the resulting protective film can exhibit a transparent frost-like appearance. Accordingly, such a protective film can make the scratch of the surface inconspicuous. In case the protective layer of the adhesive sheet is formed of the protective film, it becomes possible to clearly see the decorative surface layer through the protective film. Accordingly, such an adhesive sheet is also suited for creation of a space filled with a high-grade feeling.

As described above, a plurality of fine unevenness derived from the ceramic particles is formed on the surface of the protective film composed of the cured resin and the ceramic particles. Accordingly, in case dust and dirt adhere to the surface, a contact area between the dust and the protective film surface becomes comparatively large. In this case, a surface tension of the protective film surface is preferably reduced in order to make it possible to simply wipe off the stain caused by the dust.

To reduce the surface tension of the surface of the protective film, the protective film may contain a surfactant for coating composition. Preferred surfactant for coating composition is a fluorine-based nonionic surfactant. In such a case, bleeding to the surface portion becomes easy and the surface portion is occupied by the surfactant for coating composition. More preferred fluorine-based nonionic surfactant is made of an oligomer compound and is liquid at normal temperature (25° C.). The viscosity at normal temperature is usually less than about 50 cps, and preferably within a range from 1 to 30 cps.

The content of the surfactant is usually within a range from 0.1 to 10 parts by weight, preferably from 0.5 to 5 parts by weight, and particularly preferably from 1 to 3 parts by weight, based on 100 parts by weight of the cured resin. When the content is too small, the durability of the surface modifying effect is likely to be lowered. On the other hand, even when the content is too large, the stain resistance is not so improved and an adverse effect is likely to be exerted, to the contrary.

As the surfactant, for example, there can be used a surfactant having a perfluoroalkyl group wherein all hydrogen atoms of an alkyl group in the molecule are replaced by a fluorine atom, and a hydrophilic (e.g. hydroxyl group) or a lipophilic group. Such a compound modifies the surface of the protective film by utilizing migration of the perfluoroalkyl group to the surface and the addition of a small amount of the compound causes migration to the surface, thus making it possible to modify the surface. Specific examples of the surface modifier include fluorine-based surface modifier, DEFENSA™ series, “No. MCF-300”, “No. MCF-310”, “No. MCF-312” and “No. MCF-323”, manufactured by DAINIPPON INK & CHEMICALS Co., Ltd.

As described above, the protective layer 4 may be formed of only the above protective film, but a primer layer is preferably formed between the base layer and the protective film to enhance the adhesion between them as shown in FIG. 1. This primer layer is formed of a thermoplastic resin having light transmittance of not less than about 70%, preferably not less than about 80%, and more preferably not less than about 90%. As the thermoplastic resin, for example, polyvinyl chloride (including copolymer with other vinyl monomer), polyurethane, polyacrylate, polyester, or silicone (including silicone urea) can be used.

The primer layer usually has a thickness within a range from 10 to 200 μm, and preferably from 20 to 100 μm. When the primer layer is too thin, the mechanical durability tends to be reduced. On the other hand, when the primer layer is too thick, not only the pliability of the decorative sheet or sheet material is lowered, but also the sheet is not easily peeled off during applying again. As far as the purport of the present invention is not lost, the primer layer may contain additives such as curing agents, crosslinking agents, polymerization initiators, catalysts, surfactants, flame proofing agents, fillers, ultraviolet absorbers, antioxidants, tackifier resins, colorants and the like.

Furthermore, an intermediate layer (not shown in FIG. 1) is preferably formed between the primer layer and the protective film to further enhance the scratch resistance of the adhesive film and to enhance the adhesion between the protective film and the primer layer. The thickness of the intermediate layer is usually within a range from 1 to 90 μm. This intermediate layer is formed of a curable resin and can further contain other additives such as surfactants, stabilizers and the like, together with curing agents, crosslinking agents, curing accelerators, polymerization initiators and catalysts, which are required to cure the curable resin. As the curable resin, which constitutes the intermediate layer, the same material as the curable resin used to form the protective film is preferably used.

The adhesive layer 5 is further formed on the surface opposite the surface on which the protective layer 4 of the base layer 2 is formed. This adhesive layer can be formed of an adhesive (pressure-sensitive adhesive), a heat-sensitive adhesive or a hot melt adhesive.

Taking application of the adhesive sheet onto the floor material into consideration, this adhesive layer 5 is preferably formed of a re-releasable adhesive. This re-releasable adhesive is a mixture of elastic microspheres formed by suspension polymerization and an adhesive polymer formed by emulsion polymerization, and the adhesive layer can be provided with a lot of protruded adhesive portions derived from the elastic microspheres.

The elastic microspheres are spheres made of a material which makes the entire elastic microspheres to exhibit rubber elasticity. When the elastic microspheres have rubber elasticity, the re-releasability can be imparted to the adhesive material containing the microspheres. The microspheres means those having a volume-average diameter of less than 500 μm measured by the same manner as used in case of the ceramic particles, and the volume-average diameter is usually within a range from 10 to 300 μm. Preferred elastic microspheres are made of polyacrylate, because the rubber elasticity and adhesion can be easily controlled. The elastic microspheres preferably have a compression modulus within a range from 1×10⁴ to 1×10⁷ dyn/cm², because the elastic microspheres effectively deform and the deformation is advantageous to the re-releasability. The compression modulus of the elastic microsphers was measured at 20° C. by using a viscoelastic spectrometer (RSAII, manufactured by RHEOMETRIX).

The adhesive polymer refers to a polymer which exhibits the adhesion at normal temperature (25° C.) and is useful as a pressure-sensitive adhesive, and generally include polyacrylate, polyurethane, polyolefin or polyester and has a weight-average molecular weight within a range from 10,000 to 100,000.

The elastic microspheres and the adhesive polymer are incorporated in a predetermined ratio. Describing in detail, the elastic microspheres are usually incorporated in the amount within a range from 20 to 500 parts by weight, and preferably from 100 to 400 parts by weight, based on 100 parts by weight of the adhesive polymer.

The adhesive layer generally has a thickness within a range from 10 to 100 μm, and preferably from 15 to 60 μmm, in order to maintain the adhesion to the adherend such as floor material and to prevent an increase in thickness of the adhesive sheet.

Using a release liner having fine unevenness on the surface in place of the re-releasable adhesive, the surface (adhesive surface) of the adhesive layer may be provided with the unevenness corresponding to that of the release liner, thereby making it possible to control the adhesion or to improve removal of bubbles during the application of the adhesive sheet.

The adhesive sheet can be produced by a known conventional technique in the following manner.

First, a base material (e.g. paper) subjected to a release treatment is coated with a solution for forming a protective film, containing a curable resin, a filler and a requisite curing agent in a predetermined thickness. Then, this solution is cured by heating or irradiating with radiation, together with the base material, to form a protective film.

If necessary, the primer layer can be formed on the base material before coating with the solution for forming a protective film. In that case, the primer layer is formed by coating with a solution for forming a primer layer, containing the thermoplastic resin as described above, in a predetermined thickness, followed by heating. If necessary, an intermediate layer is also formed by coating the primer layer with a solution for forming an intermediate layer. If necessary, the above-described surface modifier for coating composition may be added to the solution for forming a protective film.

A decorative surface layer is formed on the base layer to form a laminate, separately. When the decorative surface layer is made of a print, the decorative surface layer is formed on the base layer by a known conventional technique such as screen printing, gravure printing, thermal transfer printing or the like. This base layer can also be formed by coating the base material with a solution for forming a base layer in a predetermined thickness, and curing the solution by heating or irradiating with radiation, together with the base material.

After forming the base layer and the protective film were in such a manner, the protective film (protective layer) is peeled off from the base material and a decorative surface layer of the laminate as the base layer is closely adhered to obtain an adhesive sheet. An adhesive layer is formed on the surface opposite the protective layer of the base layer.

The adhesive sheet is applied on the floor material to form a floor surface structure. As a result, such a floor surface structure is scarcely damaged because of the mechanical and chemical durability described above even when chemically or mechanically washed after exposed to comings and goings of peoples, thus making it possible to perform presentation of a varicolored space for a long period of time.

### EXAMPLES

The present invention will be described by way of the following examples. It is to be understood by a person with an ordinary skilled in the art that these examples do not place any limitation on the present invention.

### Example 1

1. Preparation of Filler

First, a composition was prepared by mixing 15 g of a zirconium oxide powder (EP, manufactured by DAIICHI KIGENSO KAGAKU KOGYO CO., LTD.) and 85 g of an aluminum oxide powder (AES-12, manufactured by SUMITOMO CHEMICAL INDUSTRIES CO., LTD.) in the presence of 100 g of water. To this composition, 0.3 g of a surfactant, which is commercially available from KAO CORPORATION under the trade name of POIZ 532A, was added to prepare a mixed solution. The mixed solution was stirred for two hours to obtain a uniform solution which was dried with heating to give a powder. The powder was stirred by a dry process for 15 minutes and then granulated to form precursor particles having a size of 106 to 180 μm. The resulting precursor particles were calcined at 1250° C. for 30 minutes. The calcined precursor particles were classified thereby to limit the size to about 180 μm or less.

Thereafter, the precursor particles were molten by gradually feeding into flame of a hydrogen-oxygen burner, and then quenched to 25° C. The precursor particles were dried and then subjected to a heat treatment at 1100° C. for five minutes to obtain ceramic particles which are useful in the present invention. As a result of observation of the appearance, the resulting ceramic particles exhibited a white color. Also the ceramic particles had a smooth surface.

2. Production of Adhesive Sheet

First, a paper base material subjected to a release treatment was coated with a polyvinyl chloride (PVC) sol to form a primer layer for heat lamination having a thickness of 50 μm. The primer layer was then coated with a solution for forming an intermediate layer with the formulation shown in Table 1, followed by drying at 90° C. for two minutes to form an intermediate layer having a thickness of 15 μm. Subsequently, the intermediate layer was coated with a solution for forming a protective film with the formulation shown in Table 1. The solution was dried at 100° C. for one minute and further dried at 160° C. for four minutes and thirty seconds to form a protective film layer integrally with the intermediate layer, thus obtaining a protective layer. The intermediate layer and the protective film layer have the total thickness of 40 μm.

Separately, the same paper base material was coated with a PVC sol in a dry thickness of 20 μm to form a base layer. Then, the base layer was subjected to printing to form a decorative surface layer.

In the same manner, a paper base material was coated with a coating solution obtained by mixing an acrylic adhesive (AROSETTO® 8167, manufactured by NIPPON SHOKUBAI CO., LTD.) with a crosslinking agent in a thickness of 40 μm, followed by drying to obtain an adhesive layer. A weight ratio (nonvolatile content) of the acrylic adhesive polymer to the crosslinking agent was 100:0.5.

Thereafter, the protective layer was peeled off from the paper base material and heat-laminated with the decorative surface layer on the base layer at the primer layer side of the protective layer. The base layer and adhesive layer were peeled off and laminated to produce an adhesive sheet of the present invention.

TABLE 1

| | | Example 1 |
|---|---|---|
| Solution for | SH-1011 | 100 |
| forming | (NIPPON POLYURETHANE INDUSTRY | |
| intermediate | CO., LTD.) | |
| layer | Coronate HX | 5 |
| | (NIPPON POLYURETHANE INDUSTRY | |
| | CO., LTD.) | |
| Solution for | SH-1011 | 100 |
| forming | (NIPPON POLYURETHANE INDUSTRY | |
| protective | CO., LTD.) | |
| film | Coronate HX | 5 |
| | (NIPPON POLYURETHANE INDUSTRY | |
| | CO., LTD.) | |
| | ZrO₂—Al₂O₃ ceramic particles | 35 |
| | Fluorine-based surface modifier | 2.4 |
| | (DAINIPPON INK & CHEMICALS Co., Ltd.) | |

### Examples 2 to 12

In the same manner as in Example 1, except that a filler made of ceramic particles prepared according to the formulation shown in Table 2, adhesive sheets were produced.

TABLE 2

| | Al₂O₃/g | ZrO₂/g |
|---|---|---|
| Example 2 | 70 | 30 |
| Example 3 | 55 | 45 |
| Example 4 | 97.5 | 2.5 |
| Example 5 | 95 | 5 |
| Example 6 | 92.5 | 7.5 |
| Example 7 | 90 | 10 |
| Example 8 | 87.5 | 12.5 |
| Exam le 9 | 82.5 | 17.5 |
| Example 10 | 80 | 20 |
| Example 11 | 77.5 | 22.5 |
| Example 12 | 75 | 25 |

### Examples 13 to 17

In the same manner as in Example 1, except that the heat treatment temperature of the precursor particles after quenching was changed as shown Table 3, adhesive sheets were produced.

TABLE 3

| | Zirconia (% | Rotational speed at which |
|---|---|---|
| | by weight) | decorative layer disappears |
| Example 1 | 15 | 2800 |
| Example 2 | 30 | 2200 |
| Example 3 | 45 | 1600 |
| Example 4 | 2.5 | 2000 |
| Example 5 | 5 | 2100 |
| Example 6 | 7.5 | 2000 |
| Examp1e 7 | 10 | 2200 |
| Example 8 | 12.5 | 2500 |
| Example 9 | 17.5 | 2700 |
| Example 10 | 20 | 2500 |
| Example 11 | 22.5 | 2400 |
| Example 12 | 25 | 2400 |
| Comp. Example | 0 | 1300 |

### Comparative Example

In the same manner as in Example 1, except that commercially available alumina particles (CB-A40, manufactured by SHOWA DENKO CO., LTD.) were used as ceramic particles, an adhesive sheet was produced.

3. Evaluation of adhesive sheets

With respect to the adhesive sheets thus produced, the abrasion resistance was evaluated by using a Taber type abrasion tester. Using a S-42 abrasive paper, the rotary speed at which the decorative surface layer disappears was determined by applying a load of 1 kg. The evaluation results are shown in Table 4.

TABLE 4

| | Heat treatment | Rotational speed at which |
|---|---|---|
| | temperature | decorative layer disappears |
| Example 13 | No heat treatment | 2500 |
| Example 14 | 400 | 2350 |
| Example 15 | 900 | 2300 |
| Example 16 | 1200 | 2300 |
| Example 17 | 1400 | 2400 |

As is apparent from the results described above, the durability of the protective film is improved by dispersing ceramic particles made of alumina and zirconia as compared with the case where particles made only of alumina are dispersed.

According to the present invention, a protective film having an excellent durability such as abrasion resistance is obtained by using ceramic particles made of alumina and zirconia as the filler. Furthermore, the ceramic particles exhibit a white color and impart frost-like appearance to the protective film, thereby making the scratch inconspicuous.

What is claimed is:

1. A protective film comprising a cured resin and a filler dispersed in said cured resin,
wherein said filler is composed of ceramic particles made of a composition containing alumina and zirconia, and
said zirconia has mainly a tetragonal crystal form and is dispersed in said ceramic particles.

2. The protective film according to claim 1, wherein said ceramic particles have an average particle diameter within a range from 10 to 150 μm.

3. The protective film according to claim 1 or 2, wherein the content of silica in said ceramic particles is within a range from 10 to 30% by weight and the content of alumina is within a range from 90 to 70% by weight.

4. An adhesive sheet comprising:
a base layer,
a protective layer which covers one surface of said base layer, and
an adhesive layer formed on the other surface of said base layer,
wherein said protective layer comprises a protective film comprising a cured resin and a filler dispersed in said cured resin,
said filler is composed of ceramic particles made of a composition containing alumina and zirconia, and
said zirconia has mainly a tetragonal crystal form and are dispersed in said ceramic particles.

5. The adhesive sheet according to claim 4, wherein a decorative surface sheet is formed on said base layer.

6. A floor surface structure comprising
a floor material, and
an adhesive sheet applied on said floor material,
wherein said adhesive sheet comprises a base layer, a protective layer which covers one surface of said base layer, and an adhesive layer formed on the other surface of said base layer,
said protective layer comprises a protective film comprising a cured resin and a filler dispersed in said cured resin,
said filler is composed of ceramic particles made of a composition containing alumina and zirconia, and
said zirconia has mainly a tetragonal crystal form and are dispersed in said ceramic particles.
